(19) United States
(12) Patent Application Publication
(10) Pub. No.: US 2026/0292339 A1
(43) Pub. Date: Sep. 24, 2026

(54) ACTUATOR FOR CAMERA

(71) Applicant: JAHWA ELECTRONICS CO., LTD., Chungcheongbuk-do (KR)

(72) Inventors: SEUNG KI KIM, Chungcheongbuk-do (KR); HEE SEUNG KIM, Chungcheongbuk-do (KR); KI HOON JEON, Chungcheongbuk-do (KR)

(21) Appl. No.: 19/563,109

(22) Filed: Mar. 11, 2026

(30) Foreign Application Priority Data
Mar. 19, 2025 (KR) 10-2025-0035586

(51) Int. Cl. H04N 23/68; G03B 5/00; H04N 23/51; H04N 23/52

(52) U.S. Cl. CPC H04N 23/687; G03B 5/00; H04N 23/51; H04N 23/52; G03B 2205/0069

(57) ABSTRACT

An actuator for a camera includes a first frame configured to move in a first direction and having a magnet, a second frame configured to support the movement of the first frame in the first direction, a ball arranged between the first and second frames, and a yoke plate provided on the second frame and configured to generate an attractive force with the magnet. The yoke plate may include a middle part, an upper part positioned above the middle part with respect to the first direction, and a lower part positioned below the middle part with respect to the first direction. An attractive force between the middle part and the magnet is greater than an attractive force between the upper part or the lower part and the magnet.

### CROSS-REFERENCE TO RELATED APPLICATIONS AND CLAIM OF PRIORITY

This application claims the benefit under 35 U.S.C. §119 of Korean Patent Application No. 10-2025-0035586 filed on Mar. 19, 2025 in the Korean Intellectual Property Office, the entire disclosure of each of which are incorporated herein by reference for all purposes.

### BACKGROUND

### Technical Field

The present disclosure relates to an actuator for a camera, and more specifically, to an optical actuator, which may effectively suppress noise generation due to collision of a carrier, etc.

### Background Art

Advances in hardware technology for image processing and growing consumer need for making and taking photos and videos have driven implementation of such functions as autofocusing (AF) and optical image stabilization (OIS) in stand-alone cameras as well as camera modules mounted on mobile terminals including cellular phones and smartphones.

An AF (autofocus) function is a function that adjusts the focal distance to a subject by linearly moving the carrier equipped with the lens, etc. in the direction of the optical axis, thereby creating a clear image by the image sensor (CMOS, CCD, etc.) located at the rear of the lens.

An optical image stabilization (OIS) function means a function of improving the sharpness of an image by adaptively moving the carrier having a lens (or image sensor) in a direction to compensate for the shaking when the lens is shaken due to trembling.

One of representative methods to implement autofocus or OIS is to use the magnetic force (electromagnetic force) between a magnet (coil) installed on a moving body (carrier) and a coil (magnet) installed on a fixed body (housing, base, or other types of carrier) to move the moving body. In this case, a ball is placed between the moving body and the fixed body to guide the movement of the moving body.

If an external force such as an external shock or shaking is applied to the actuator, the moving body, which is an internal component such as a carrier, may collide with the housing (case, base, etc.) of the actuator.

The internal components of the actuator vary in structure and shape, and are made of different materials such as plastic and metal. Therefore, if a physical collision occurs between the internal components, noise may be generated, and also wear, damage, and destruction of the internal components may also occur.

In the case of actuators in which internal components are heavy or the carrier has a travel distance as in a folded actuator, the physical impact is greater, so problems caused by collisions between internal components may be more severe.

If wear and damage occur to the internal components in this way, the possibility of malfunction increases in itself, and foreign substances such as particles (particles, debris, etc.) detached from the internal components are generated and scattered, which reduces operating precision and may significantly affect image quality, such as the occurrence of dead pixels in image pickup devices such as CCDs.

To solve these problems, a damper made of a material such as rubber, foam rubber, Poron, or foam resin is provided as a type of cushioning member that may alleviate the impact on objects that may experience physical collision.

However, if the damper is continuously exposed to external impact, the stress may accumulate and be concentrated in the damper, which may cause plastic deformation in which the damper permanently loses its designed level of elasticity, and cracks may occur in the damper or the damper itself may be physically damaged or worn out.

In this case, the damper itself may become the cause of foreign matter generation, and the damper cannot perform its original function, so the actuator may be exposed to various problems caused by collisions between internal components.

### SUMMARY

The present disclosure is designed to solve the problems of the related art, and therefore the present disclosure is directed to providing an actuator for a camera, which may weaken and minimize collisions by differentiating the attractive force between the magnet and the yoke plate so that the attractive force acts in a direction opposite to the direction in which the moving body collides with the fixed body.

Other technical goals and advantages of the present invention can be understood with reference to the description below, which will be made explicit by the accompanied examples. Furthermore, the technical goals and advantages of the present invention can be accomplished by the embodiments and their combinations recited in the attached claims.

An actuator for a camera according to an embodiment of the present disclosure may comprise a first frame configured to move in a first direction and having a magnet; a second frame configured to support the movement of the first frame in the first direction; a ball arranged between the first and second frames; and a yoke plate provided on the second frame and configured to generate an attractive force with the magnet. In this case, the yoke plate of the present disclosure may include a middle part; an upper part positioned above the middle part with respect to the first direction; and a lower part positioned below the middle part with respect to the first direction, and an attractive force between the middle part and the magnet may be greater than an attractive force between the upper part or the lower part and the magnet.

Preferably, an area of the middle part of the present disclosure facing the magnet may be greater than an area of the upper part or the lower part facing the magnet.

In addition, at least one of the upper part and the lower part of the present disclosure may include at least one open portion that does not generate an attractive force with the magnet.

Furthermore, a height of the middle part in the first direction may be smaller than a height of the magnet in the first direction.

Preferably, a height difference between a highest portion of the upper part in the first direction and a lowest portion of the lower part in the first direction may be greater than the height of the magnet in the first direction.

In addition, at least one of the upper part and the lower part may include a region having a smaller thickness than the middle part.

The actuator for a camera according to the present disclosure may further comprise a first rail provided on at least one of the first and second frames and having a U-shaped cross-section; and a second rail provided on at least one of the first and second frames in parallel with the first rail and having a V-shaped cross-section.

In this case, the ball of the present disclosure may be arranged on the first and second rails, respectively, and the open portion of the present disclosure may be formed at a position biased toward the first rail.

According to an embodiment of the present disclosure, the collision or impact between the moving body and the fixed body may be mitigated, thereby more effectively suppressing unnecessary noise generation.

According to an embodiment of the present disclosure, the collision between the moving body and the fixed body is suppressed or minimized in a non-contact manner using a magnetic force (attractive force) rather than using physical materials, etc., so that the service life may be extended significantly.

According to an embodiment of the present disclosure, the generation of foreign substances, etc. may be significantly reduced during the process of collision suppression or mitigation, thereby further improving the operating precision of the actuator.

According to an embodiment of the present disclosure, a relatively strong return force is provided to the U-shaped rail portion where a gap, etc. may occur in relation to the ball, so that the impact between the moving body and the fixed body may be more effectively suppressed.

In addition, in the present disclosure, when a shock mitigating means such as a damper is applied together, the shock or stress applied to the damper may be reduced, which may more effectively induce the continued use of the damper, and fatigue destruction of the damper, stress concentration, and plastic deformation of the damper due to accumulation may be more effectively prevented.

### BRIEF DESCRIPTION OF THE DRAWINGS

The accompanying drawings illustrate a preferred embodiment of the present disclosure and together with the foregoing disclosure, serve to provide further understanding of the technical features of the present disclosure, and thus, the present disclosure is not construed as being limited to the drawing.

FIGS. 1 and 2 are diagrams showing the overall configuration of an actuator for a camera according to a preferred embodiment of the present disclosure,

FIG. 3 is a drawing for illustrating a driving unit of an OIS carrier,

FIG. 4 is a cross-sectional view showing the internal structure of the actuator for a camera according to an embodiment of the present disclosure,

FIG. 5 is a drawing for illustrating the relationship between a coil, a magnet, and a position sensor (Hall sensor),

FIGS. 6 and 7 are for illustrating showing a yoke plate according to an embodiment of the present disclosure, and

FIGS. 8-10 are drawings for illustrating a yoke plate according to another embodiment of the present disclosure.

### DETAILED DESCRIPTION

Hereinafter, preferred embodiments of the present disclosure will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present disclosure on the basis of the principle that the inventor is allowed to define terms appropriately for the best explanation.

Therefore, the description proposed herein is just a preferable example for the purpose of illustrations only, not intended to limit the scope of the disclosure, so it should be understood that other equivalents and modifications could be made thereto without departing from the scope of the disclosure.

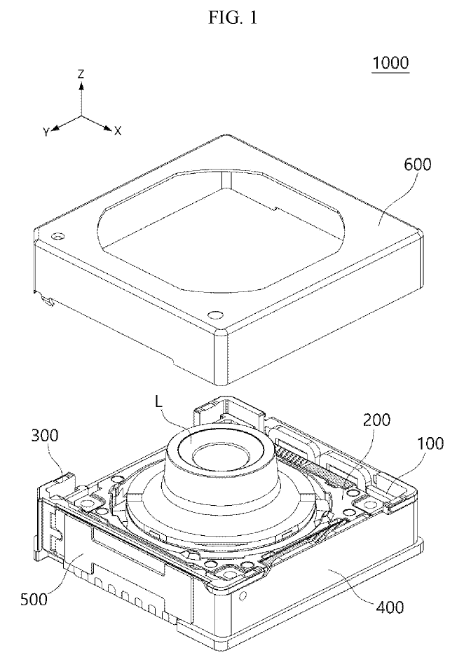

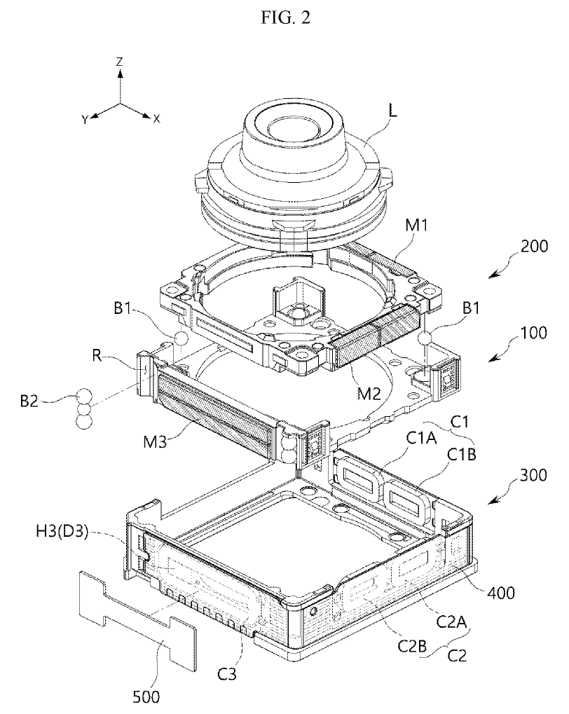

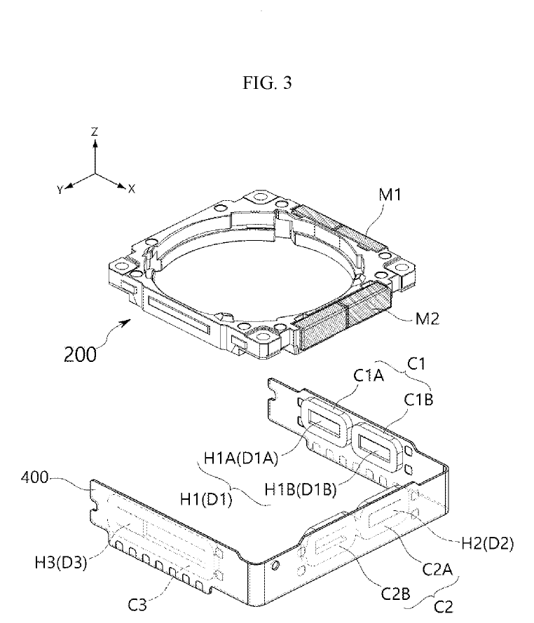

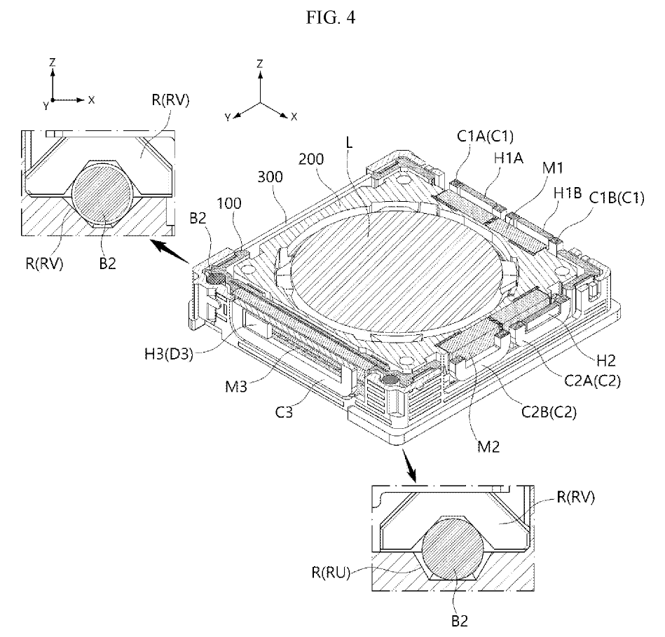

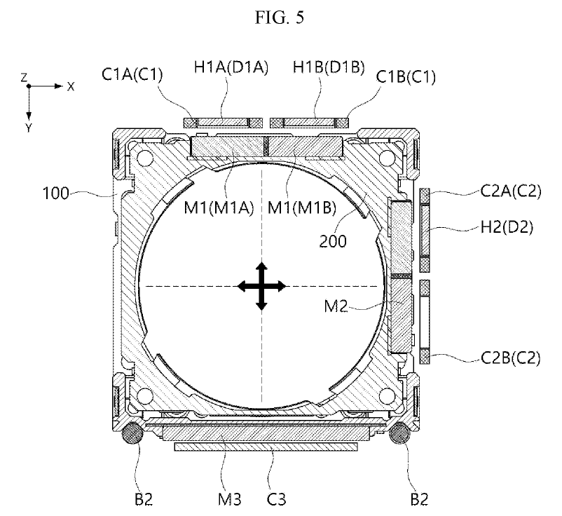

FIGS. 1 and 2 are diagrams showing the overall configuration of an actuator 1000 for a camera (hereinafter, referred to as an ‘actuator’) according to a preferred embodiment of the present disclosure, FIG. 3 is a drawing for illustrating a driving unit of a third frame 200 that is an OIS carrier, FIG. 4 is a cross-sectional view showing the internal structure of the actuator 1000 according to an embodiment of the present disclosure, and FIG. 5 is a drawing for illustrating the relationship between a coil, a magnet, and a position sensor (Hall sensor).

Hereinafter, with reference to FIGS. 1-5, the overall configuration of the present disclosure and the operational relationship in which AF and OIS are performed will first be described, and the yoke plate 500 of the present disclosure, which suppresses collision between internal components by using a differential magnetic force (attractive force), will be described in detail later.

The actuator 1000 of the present disclosure illustrated in FIG. 1 and the attached drawings below is an embodiment in which AF and OIS are implemented together, but the actuator 1000 of the present disclosure may be implemented as an actuator for AF only, depending on an embodiment. In addition, the actuator 1000 of the present disclosure may also be implemented as an actuator including a carrier (frame) that moves in a direction in which a reflector is provided, such as a folded actuator.

In addition, the actuator 1000 of the present disclosure may be implemented as a standalone device, and may also be implemented in the form of a camera module including an image sensor (not shown), etc.

As illustrated in FIG. 1, etc., the actuator 1000 of the present disclosure may be configured to include a first frame 100, a second frame 300, and a third frame 200.

The Z-axis direction illustrated in FIG. 1, etc. is an optical axis direction, which is a direction in which light enters a lens or lens assembly L. When AF is driven, the Z-axis direction corresponds to a direction in which the first frame 100 moves forward and backward with the second frame 300 as a relative fixed body, and the X-axis and Y-axis perpendicular to the optical axis correspond to a direction in which the third frame 200 moves when OIS is driven.

It is obvious that the axes depicted in the drawings, terms referring to the axes, and terms such as “upper”, “lower”, “front”, “rear”, “vertical”, “horizontal”, etc., which are explained based on the axes, are only intended to provide relative standards for explaining the embodiment of the present disclosure, and are not intended to specify any direction or position on an absolute basis, and may of course be relatively varied depending on the position of a target object, the position of an observer, the direction of view, etc.

The second frame 300 of the present disclosure may correspond to a basic frame structure that accommodates internal components of the actuator 1000 according to the present disclosure, and may be coupled with a case 600 that functions as a shield can according to an embodiment.

The third frame 200 corresponds to an OIS carrier or OIS frame that moves on a plane (XY plane in the drawing) perpendicular to the optical axis with the first frame 100 or the second frame 300 as a relatively fixed body. If a lens or image sensor is mounted on the third frame 200, the lens L, etc. move according to the movement of the third frame 200, thereby implementing OIS that eliminates external disturbance phenomena such as hand shake.

Hereinafter, based on the embodiment illustrated in the drawing, the first frame 100 is referred to as an AF carrier 100, the second frame 300 is referred to as a housing 300, and the third frame 200, which is a moving body that moves on a plane perpendicular to the optical axis when the OIS is driven, is referred to together as an OIS carrier 200.

The first frame 100 of the present disclosure may be a moving body that moves in a specific direction, such as a moving body for zoom operation as described above, or a moving body that moves in a direction perpendicular to the direction in which light from a subject enters.

Considering this point, the direction in which the first frame 100 moves is referred to as a first direction, and if the first frame 100 of the present disclosure is a moving body for implementing AF, the first direction may be the Z-axis direction (optical axis direction) illustrated in the drawings.

The first ball B1 may be arranged between the OIS carrier 200 and the AF carrier 100. If the AF is not implemented integrally, the first ball B1 may be arranged between the OIS carrier 200 and the housing 300, which corresponds to a relative fixed body of the OIS carrier 200.

If the first ball B1 is provided in this way, an appropriate gap is maintained between the OIS carrier 200 and the AF carrier 100, and the OIS carrier 200 may move more flexibly due to the minimized friction caused by moving, rolling, etc. of the first ball B1, thereby further improving noise reduction, minimization of driving force, and driving precision.

At least one of the AF carrier 100 and the OIS carrier 200 may include a pocket portion that accommodates the first ball B1 and prevents the first ball B1 from being ejected externally.

A first magnet M1 facing the first coil unit C1 and a second magnet M2 facing the second coil unit C2 may be installed on the OIS carrier 200. For directional control, it is preferable that the first and second magnets M1, M2 are arranged perpendicular to each other.

If power of an appropriate magnitude and direction is supplied to the first coil unit C1 through the control of the first operation drive D1, a magnetic force (electromagnetic force) is generated between the first magnet M1 installed in the OIS carrier 200 and the first coil unit C1, and the OIS carrier 200 moves in the Y-axis direction with the AF carrier 100 or the housing 300 as a relative fixed body using the generated magnetic force as a driving force. Through this movement control, external disturbances such as hand shake in the Y-axis direction are corrected.

If power of an appropriate magnitude and direction is supplied to the second coil unit C2 through the control of the second operation drive D2, a magnetic force (electromagnetic force) is generated between the second magnet M2 installed in the OIS carrier 200 and the second coil unit C2, and the OIS carrier 200 moves in the X-axis direction with the AF carrier 100 or housing 300 as a relative fixed body using the generated magnetic force as a driving force. Through this movement control, the OIS in the X-axis direction is implemented.

Depending on an embodiment, a position sensor H1, H2 that detects the position, movement direction, movement size, etc. of the OIS carrier 200 may be further included. If the position sensor detects the position, etc. of the OIS carrier 200 and transmits a corresponding signal to the operation drive (control unit), the operation drive controls power of the corresponding magnitude and direction to be supplied to the coil unit.

The position sensor may be implemented as a Hall sensor that uses the Hall effect to detect the change in magnitude or/and direction of the magnetic field of a magnet existing within a detection area and outputs an electrical signal accordingly.

The first Hall sensor (first position sensor) H1 of the present disclosure is configured to detect the magnitude of the magnetic field that changes depending on the position of the first magnet M1, etc., and output a corresponding signal.

If the first Hall sensor H1 detects the position of the first magnet M1 installed on the OIS carrier 200 and outputs a corresponding signal to the first operation drive D1, the first operation drive D1 controls power of the corresponding magnitude and direction to be supplied to the first coil unit C1.

The first Hall sensor H1 may include a plurality of Hall sensors H1A, H1B arranged to face at least one first magnet M1 at different positions so as to effectively detect the rotation component of the OIS carrier 200.

As an example, FIG. 5 shows a left Hall sensor H1A facing the left (based on FIG. 5) part M1A of the first magnet M1 and a right Hall sensor H1B facing the right part M1B of the first magnet M1.

Correspondingly, the first operation drive D1 may also include a plurality of operation drives D1A, D1B, and the first coil unit C1 may also include a plurality of coils C1A, C1B, which are independently controlled by the first operation drives D1A, D1B, respectively.

For the relative distinction of coils, the coils included in the first coil unit C1 are referred to as a first coil C1A and a second coil C1B.

If the rotation component of the OIS carrier 200 is detected through detection of a plurality of first Hall sensors H1A, H1B, each of the first operation drives D1A, D1B controls the magnitude of current, etc. supplied to the first coil C1A and the second coil C1B so that the rotation component of the OIS carrier 200 may be corrected.

For example, if a clockwise rotation component of the OIS carrier 200 is detected, the rotation component of the OIS carrier 200 may be compensated by controlling the magnitude of the current applied to the second coil C1B to be relatively larger than the magnitude of the current applied to the first coil C1A.

Depending on an embodiment, the clockwise rotation component of the OIS carrier 200 may be controlled to be compensated by controlling so that an attractive force is generated between the first coil C1A and the first magnet M1 and a repulsive force is generated between the second coil C1B and the first magnet M1.

If the magnitude, etc. of the magnetic field detected by the plurality of first Hall sensors H1A, H1B is the same, this means that the first magnet M1, i.e., the OIS carrier 200, moves linearly or maintains its position.

However, if the magnitude of the magnetic field detected by the plurality of first Hall sensors H1A, H1B is different, this means that the posture of the OIS carrier 200 is not correct.

In order to more effectively compensate for the rotation component of the OIS carrier 200, it is preferable that the first coil C1A, which is one of the first coil units C1, is controlled by the first Hall sensor H1A and the first operation drive D1A, and the second coil C1B, which is another of the first coil units C1, is controlled by the first Hall sensor H1B and the first operation drive D1B. In other words, it is preferable that the first coil C1A and the second coil C1B are configured to be driven or controlled independently.

The second Hall sensor (second position sensor) H2 of the present disclosure is configured to detect the magnitude of the magnetic field that changes depending on the position of the second magnet M2, etc., and output a corresponding signal.

In order to increase the precision of rotation component detection of the OIS carrier 200 or to supplement or complement rotation component detection of the OIS carrier 200, the second Hall sensor H2 may also be implemented as a plurality of Hall sensors, like the first Hall sensor H1. According to an embodiment, as illustrated in the drawings, rotation component detection of the OIS carrier 200 may be configured to be implemented in any one of the first Hall sensor H1 and the second Hall sensor H2.

If the second Hall sensor H2 detects the position of the second magnet M2 installed on the OIS carrier 200 and outputs a corresponding signal to the second operation drive D2, the second operation drive D2 may control power of the corresponding magnitude and direction to be cyclically supplied to the second coil unit C2.

As illustrated in the drawings, it is preferable that the second coil unit C2 includes a plurality of coils for enhancing driving efficiency and driving force. For the relative distinction of coils, the coils included in the second coil unit C2 are referred to as a third coil C2B and a fourth coil C2A.

It is preferable that the first coil C1A and the second coil C1B of the first coil unit C1 are arranged to face the first magnet M1 at different positions and are driven independently, and the third coil C2B and the fourth coil C2A of the second coil unit C2 are arranged to face the second magnet M2 at different positions and are driven in conjunction. The first and second magnets M1, M2 may be implemented as one or more magnets.

According to the embodiment of the present disclosure, the Y-axis directional OIS of the OIS carrier 200 is implemented by the first coil unit C1 and the first magnet M1, the X-axis directional OIS of the OIS carrier 200 is implemented by the second coil unit C2 and the second magnet M2, the rotation correction of the OIS carrier 200 is implemented through independent control of the first coil C1A and the second coil C1B of the first coil unit C1, and the driving force of the X-axis directional OIS may be enhanced.

If a plurality of coils included in the second coil unit C2 are controlled to be interlocked, i.e., to have the same directionality of driving force, it may be desirable that the size of the third coil C2B facing the second magnet M2 is differently configured from the size of the fourth coil C2A facing the second magnet M2.

Certain regions at both ends of the magnet are variable regions where the magnetic field varies significantly, and it is difficult to implement drive control linearly. Therefore, by configuring individual coils so that their size or area facing the magnet is differentiated, the variable region of the magnet facing the individual coil may be eliminated as much as possible, improving both driving force enhancement and linear control characteristics.

In this case, the second Hall sensor H2 facing the second magnet M2 is arranged in the inner space of the third coil C2B, which has a larger area facing the second magnet M2 among the third coil C2B and the fourth coil C2A, and is preferably arranged in a position biased in a direction in which the fourth coil C2A is provided.

In the embodiment of the present disclosure, even if the OIS carrier 200 rotates due to external factors, the second Hall sensor H2 may face an area of the second magnet M2 where the change in position or posture is relatively smallest. Therefore, the magnetic field of the second magnet M2 may be detected in an environment where the influence of the rotation of the OIS carrier 200 is minimized, thereby improving the driving precision of rotation detection and rotation correction.

The AF carrier 100 corresponds to a moving body that implements AF by moving in the first direction (optical axis direction) with the housing 300 as a relative fixed body.

In order to guide the movement of the AF carrier 100 in the optical axis direction, at least one of the AF carrier 100 and the housing 300 may include a rail R having a shape extending in the optical axis direction and on which the second ball B2 is arranged.

The rails R may be arranged parallel at both sides of the third magnet M3 as illustrated in the drawings to stably guide the movement of the AF carrier 100, and may be arranged to face each other on the AF carrier (first frame) 100 and the housing (second frame) 300 to effectively linearly guide the AF carrier 100 and the second ball B2.

One of the plurality of rails R on which the second ball B2 is arranged may be configured such that its cross-section (vertical cross-section based on the optical axis direction) has a “U” shape, and the other may be configured such that its cross-section has a “V” shape. Hereinafter, the rail having a “U”-shaped cross-section is referred to as a “U-rail or first rail RU”, and the rail having a “V-shaped” cross-section is referred to as a “V-rail or second rail RV” (see FIG. 4).

If the cross sections of the plurality of rails R are configured to have different geometrical characteristics in this way, the contact area and rotational characteristics of the second ball B2 may be configured differently, thereby improving the driving characteristics such as the linear movement and driving efficiency of the first frame (AF carrier) 100 moving in the first direction.

If the rail R of the AF carrier 100 and the rail R of the housing 300 facing the rail R of the AF carrier 100 are both V-rails, the rails are arranged so that the wide areas of the grooves face each other, and the second ball B2 is arranged therebetween. Therefore, the second ball B2 comes into point contact with the rail RV of both the AF carrier 100 and the housing 300, and due to this contact relationship, the AF carrier 100 moves with more precise linearity.

Here, the cross-section being formed in a ‘V shape’ means that this has not only a shape corresponding to the alphabet “V”, but also a shape in which the ball contacts the inner side of the rail at two points. The cross-section being formed in a ‘U shape’ means that this has not only a shape corresponding to the alphabet “U”, but also a shape in which a certain amount of free space may exist between the ball and the rail.

If the rail R provided in any one of the AF carrier 100 and the housing 300 is the first rail RU (U-rail), it may be desirable for linear movement of the AF carrier 100 that the other rail arranged parallel thereto is a V-rail.

The drawing shows a preferred embodiment thereof, in which all rails R provided in the AF carrier 100 are V-rails, and one of the rails R provided in the housing 300 is a V-rail and the other is a U-rail.

A third magnet M3 that faces the AF coil C3 installed on the housing 300 is installed on the AF carrier 100. If power of an appropriate magnitude and direction is supplied to the AF coil C3 through detection by the AF Hall sensor H3 and control by the AF operation drive D3, an electromagnetic force (magnetic force) is generated between the AF coil C3 and the third magnet M3, and the AF carrier 100 moves in the optical axis direction using the electromagnetic force as a driving force.

If the AF carrier 100 moves in the optical axis direction, the OIS carrier 200 on which a lens, etc. is mounted also moves in the optical axis direction together with the AF carrier 100.

If the AF carrier 100 moves forward and backward in the optical axis direction in this way, the distance between the lens and an image sensor (not shown), such as a CCD (Charged-Coupled Device) or CMOS (Complementary Metal-Oxide Semiconductor) provided at the rear end of the actuator 1000 (based on the optical axis direction), is adjusted, thereby implementing an auto-focus function or a zoom function.

The actuator 1000 of the present disclosure may include a yoke plate 500 provided in the housing 300 to generate an attractive force with the third magnet M3.

Since the AF carrier 100 mediated by the second ball B2 is pulled in the direction toward the housing 300 (based on the Y-axis direction in the drawing) by the attractive force between the yoke plate 500 and the third magnet M3, point contact, etc. between the second ball B2 and the AF carrier 100 and between the second ball B2 and the housing 300 is continuously maintained.

In order to effectively implement linear guiding, it is preferable that the second ball B2 is provided to be partially accommodated in the rail R formed on at least one of the AF carrier 100 and the housing 300.

If the second ball B2 is provided in at least one of the AF carrier 100 and the housing 300 in this way, the AF carrier 100 may move linearly more flexibly with minimized friction due to moving, rolling, etc. of the second ball B2.

It is preferable that the circuit board 400, on which coils C1, C2, C3, Hall sensors H1, H2, H3, etc. are mounted, is provided in the housing 300 located at the outermost side of the actuator 1000 for interfacing with external devices, etc.

The first operation drives D1A, D1B may be implemented as independent electronic components, elements, etc., but may also be implemented as a single electronic component (chip) integrated with the first Hall sensor H1A, H1B through SOC (System On Chip), etc. In this respect, the first Hall sensor H1A and the first operation drive D1A, and also the first Hall sensor H1B and the first operation drive D1B are shown in the same configuration in the drawing. The second operation drive D2 and/or the AF operation drive D3 are also the same.

The operation drive may be provided in the same number of individual Hall sensors and implemented as a single chip with the individual Hall sensors. However, depending on an embodiment, the operation drive may not be provided in the same number of individual Hall sensors and may be implemented as a single chip with some of the individual Hall sensors through channel adjustment for electrical connection with the Hall sensors.

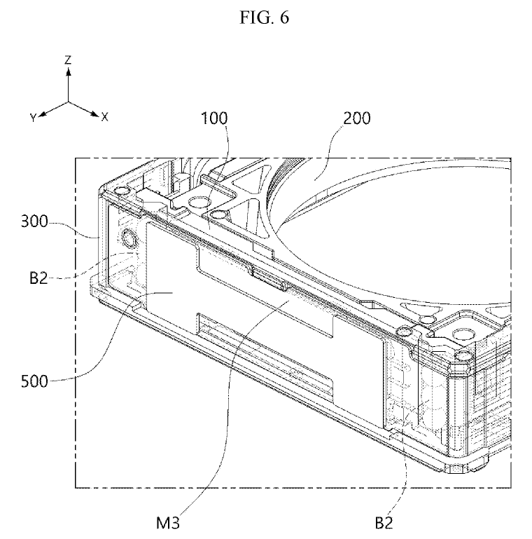

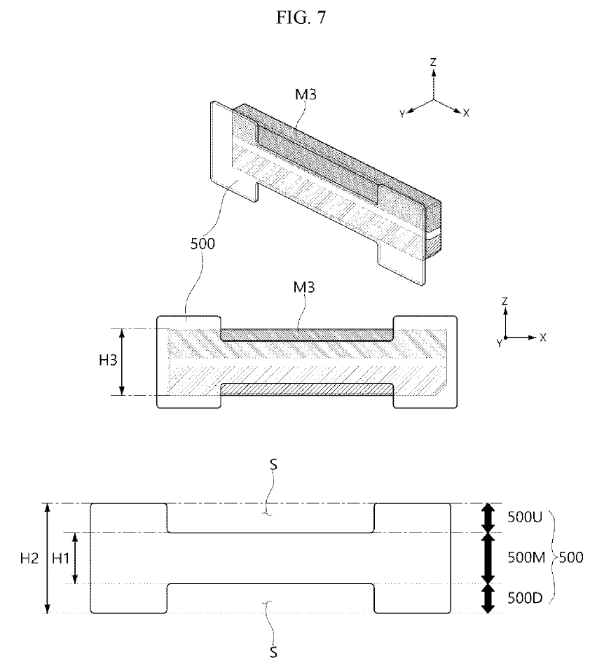

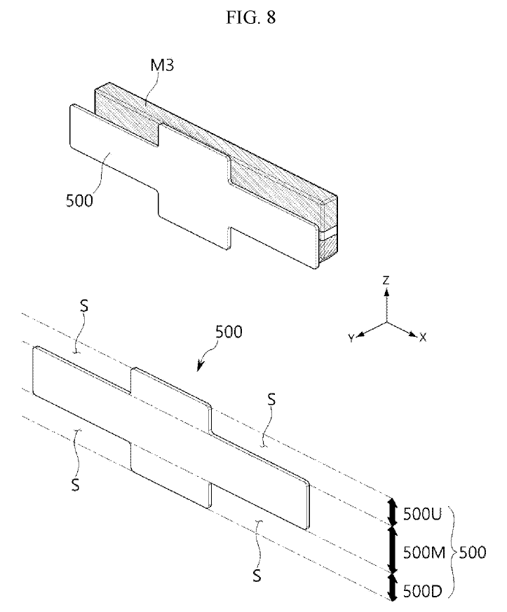

FIGS. 6 and 7 are for illustrating showing a yoke plate 500 according to an embodiment of the present disclosure, and FIGS. 8-10 are drawings for illustrating a yoke plate 500 according to another embodiment of the present disclosure.

Hereinafter, with reference to the attached drawings, the structure, function, etc. of the yoke plate 500 according to the embodiment of the present disclosure will be described in detail.

As described above, the actuator 1000 of the present disclosure may include a first frame 100 moving in the first direction, a second frame 300 supporting the movement of the first frame 100 in the first direction, and a ball (second ball B2) arranged between the first frame 100 and the second frame 300.

If the first frame 100 corresponds to a moving body for AF as in the embodiment illustrated in the drawing, the movement direction of the first frame 100 is the optical axis direction (based on the Z-axis direction in the drawing), but if the first frame 100 is applied to another type of actuator, such as an actuator that implements folded zoom, the movement direction (first direction) of the first frame 100 may be a direction different from the optical axis direction.

In addition, since the second frame 300 corresponds to a relative fixed body of the first frame 100 moving in the first direction, the second frame 300 may be the housing 300 as in the embodiment illustrated in the drawing, but depending on an embodiment, the second frame 300 may also be another moving body.

As defined above, the first frame 100 moving in the first direction based on the embodiment illustrated in the drawing is described as the AF carrier 100 moving in the optical axis direction for implementing AF, and the second frame 300, which is a relative fixed body of the first frame 100 moving in the first direction, is described as the housing 300.

The yoke plate 500 of the present disclosure installed in the housing 300 generates an attractive force with the magnet (third magnet) M3 installed on the AF carrier 100 moving in the optical axis direction, so that the first frame 100 is brought into close contact with the housing 300 in a state where the second ball B2 is mediated.

It is desirable that the height (based on the optical axis direction) of the yoke plate 500 is set so that this adhesion may be maintained throughout the entire movement area (stroke) of the AF carrier 100.

The yoke plate 500 prevents the magnetic force of the third magnet M3, etc. from leaking to the outside, and if the magnetic force acts between the third coil C2B and the third magnet M3, it also performs the function of increasing the driving efficiency by inducing the magnetic force to be concentrated toward the third magnet M3.

If current is supplied to the AF coil C3, a magnetic force is generated between the AF coil C3 and the third magnet M3, and the AF carrier 100 on which the third magnet M3 is installed moves in the first direction according to the magnitude and/or direction of the generated magnetic force.

If AF is not performed, such as when power is not supplied to the AF coil C3, the third magnet M3 is not affected by the magnetic force caused by the AF coil C3, but is affected by the attractive force caused by the yoke plate 500.

An attractive force is constantly applied between the third magnet M3 installed in the first frame 100, which is a moving body, and the yoke plate 500 installed in the housing 300. The direction of the attractive force is a horizontal direction (Y-axis direction in the drawing) perpendicular to the optical axis direction (upper and lower direction), and the magnitude of the attractive force is the same throughout the entire area in which the magnet can move.

Although the attractive force between the yoke plate 500 and the third magnet M3 acts as a normal force for the movement of the AF carrier 100 in the upper and lower direction, the frictional force is extremely small because the second ball B2 is mediated between the AF carrier 100 and the housing 300.

Therefore, if an external force (shaking, vibration, impact, etc.) is applied to the actuator or a mobile terminal in which the actuator is installed, the attractive force between the yoke plate 500 and the third magnet M3 has difficulty in functioning as a force to offset or suppress the external force.

For this reason, in a conventional actuator, if an external force is applied, the carrier inside the actuator moves in the upper and lower direction with a force corresponding to the external force and collides with the housing, the case, etc., so the problem mentioned above occurs.

The yoke plate 500 of the present disclosure is a key component of the present disclosure that effectively addresses the above problem through simple structural improvements.

The yoke plate 500 of the present disclosure may specifically include an upper part 500U, a middle part 500M, and a lower part 500D.

The middle part 500M is a center part of the yoke plate 500 in the optical axis direction (first direction), and the upper part 500U is a part of the yoke plate 500 located above the middle part 500M based on the first direction (the direction in which the first frame 100 moves). The lower part 500D of the yoke plate 500 is a part located below the middle part 500M based on the first direction (optical axis direction).

The yoke plate 500 according to the present disclosure is configured such that the attractive force between the middle part 500M and the third magnet M3 is greater than the attractive force between the upper part 500U and the third magnet M3 or/and the attractive force between the lower part 500D and the third magnet M3.

That is, according to the present disclosure, the magnitude of the magnetic force of the yoke plate 500 in relation to the third magnet M3 is differentiated based on the height direction (first direction, optical axis direction), so that the upper (top) or/and lower (bottom) part has a relatively small magnetic force, and the middle part has a relatively large magnetic force.

Therefore, if the AF carrier 100 moves upward or downward or if the AF carrier 100 is positioned upward or downward, a force (return force) to return the AF carrier 100 equipped with the third magnet M3 to the position of the middle part 500M of the yoke plate 500 is naturally formed, and this return force acts in a direction that offsets the external force.

That is, if the third magnet M3 installed on the AF carrier 100 moves upward, an attractive force having a downward orientation may be induced to act on the third magnet M3, and if the third magnet M3 moves downward, an attractive force having an upward orientation may be induced to act on the third magnet M3.

The yoke plate 500 of the present disclosure induces an attractive force (return force) in the downward direction (-Z-axis direction in the drawing) to be applied to the AF carrier 100 moving upward (+Z-axis direction in the drawing) by an external force, thereby suppressing the AF carrier 100 from colliding with other components (case, housing, etc.) provided in the upward direction, and may weaken the impact amount even if the AF carrier 100 collides with other components. This also applies to the case where the AF carrier 100 moves downward by an external force.

In this case, according to the embodiment of the present disclosure, if the AF carrier 100 moves upward or downward due to an external force, an attractive force in a direction opposite to the moving direction acts on the third magnet M3, so that a collision between the AF carrier 100 and other components may be suppressed.

As an embodiment for this, the area of the upper part 500U of the yoke plate 500 facing the third magnet M3 may be configured to be smaller than the area of the middle part 500M of the yoke plate 500 facing the third magnet M3.

To correspond thereto, the area of the lower part 500D of the yoke plate 500 facing the third magnet M3 may be configured to be smaller than the area of the middle part 500M of the yoke plate 500 facing the third magnet M3.

Specifically, the upper part 500U or/and the lower part 500D may include an open portion S, which is a space that does not generate a magnetic force with the third magnet M3, as illustrated in FIGS. 7 and 8.

If the upper part 500U or/and the lower part 500D include the open portion S in this way, the area of the surface facing the third magnet M3 may be effectively reduced. Various modifications, including the forms illustrated in the drawings, are possible in terms of the size, position, number, arrangement, etc. of the open portion S as long as the magnitude of the magnetic force may be differentiated.

If the third magnet M3 moves upward or downward, it is preferable that the height H1 (see FIG. 7) of the middle part 500M in the first direction (optical axis direction) is smaller than the height H3 (see FIG. 7) of the third magnet M3 in order to enhance the restoring force in the reverse direction.

In order to ensure that the close contact between the AF carrier 100 and the housing 300 may be maintained throughout the entire movement area (stroke) of the AF carrier 100, it is preferable that the height difference H2 (see FIG. 7) between the highest portion of the upper part 500U in the first direction and the lowest portion of the lower part 500D in the first direction is greater than the height H3 (see FIG. 7) of the third magnet M3 in the first direction.

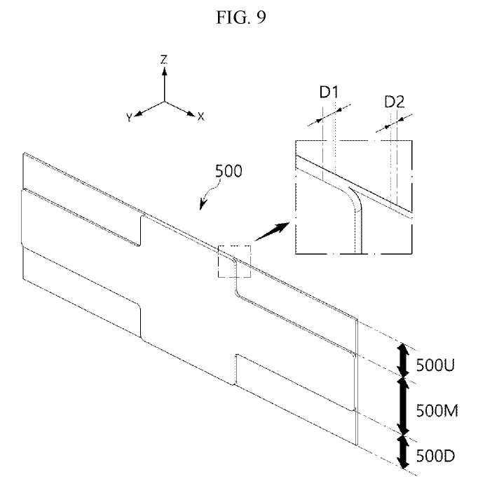

The embodiment illustrated in FIG. 9 corresponds to an embodiment in which the magnetic force of the yoke plate 500 is differentiated according to the height (first direction) by making the thickness D2 of the upper part 500U or/and the lower part 500D thinner (D2<D1) than the thickness D1 of the middle part 500M.

If the yoke plate 500 of the present disclosure is implemented in the form illustrated in FIG. 9, the magnetic force of the upper part 500U and/or the lower part 500D may be made relatively small in relation to the third magnet M3, and the magnetic force of the middle part 500M may be made relatively large. In addition, in this embodiment, the area that prevents external leakage of the magnetic field may also be expanded.

As described above, the AF carrier 100 or/and the housing 300 may include a rail R that accommodates the second ball B2 and guides the movement of the AF carrier 100 in the optical axis direction, and a V-rail (second rail RV) may be provided at one of the left and right sides of the third magnet M3, and a U-rail (first rail RU) may be provided at the other side.

The second ball B2, which is accommodated in the second rail RV whose vertical cross-section is V-shaped, is in point contact with the second rail RV, so there is almost no gap between the second ball B2 and the second rail RV.

In contrast, the second ball B2, which is accommodated in the first rail RU having a vertical cross-section of U shape, does not always contact the first rail RU, so a gap may occur between the second ball B2 and the first rail RU.

Therefore, when an external force (shaking, vibration, impact, etc.) is applied to the actuator 1000, the movement of the AF carrier 100 due to the external force is likely to occur in advance in the area of the second rail RV, and its physical displacement is also likely to be large.

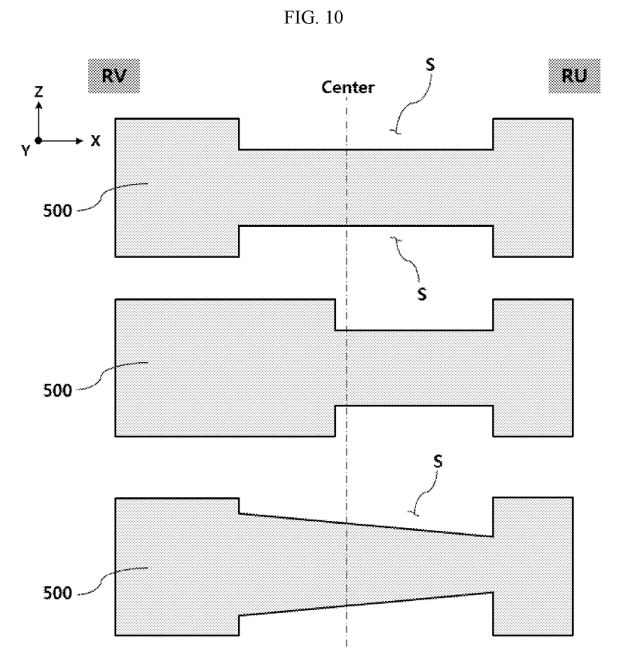

In order to effectively solve this problem, as illustrated in FIG. 10, it is preferable that the open portion S of the upper part 500U and/or the open portion S of the lower part 500D is provided at a position biased toward the first rail RU.

If configured in this manner, a relatively large return force may be induced to occur in the first rail RU, thereby more effectively suppressing movement of the AF carrier 100 caused by external force in the area of the first rail RU.

The present disclosure has been described in detail. However, it should be understood that the detailed description and specific examples, while indicating preferred embodiments of the disclosure, are given by way of illustration only, since various changes and modifications within the scope of the disclosure will become apparent to those skilled in the art from this detailed description.

In the above description of this specification, the terms such as “first” and “second” etc. are merely conceptual terms used to relatively identify components from each other, and thus they should not be interpreted as terms used to denote a particular order, priority or the like.

The drawings for illustrating the present disclosure and its embodiments may be shown in somewhat exaggerated form in order to emphasize or highlight the technical contents of the present disclosure, but it should be understood that various modifications may be made by those skilled in the art in consideration of the above description and the illustrations of the drawings without departing from the scope of the present invention.

What is claimed is:

1. An actuator for a camera, comprising:
a first frame configured to move in a first direction and having a magnet;
a second frame configured to support the movement of the first frame in the first direction;
a ball arranged between the first and second frames; and
a yoke plate provided on the second frame and configured to generate an attractive force with the magnet, the yoke plate comprising:
a middle part;
an upper part positioned above the middle part with respect to the first direction; and
a lower part positioned below the middle part with respect to the first direction,
wherein an attractive force between the middle part and the magnet is greater than an attractive force between the upper part or the lower part and the magnet.

2. The actuator for a camera according to claim 1, wherein an area of the middle part facing the magnet is greater than an area of the upper part or the lower part facing the magnet.

3. The actuator for a camera according to claim 2, wherein at least one of the upper part and the lower part includes at least one open portion that does not generate an attractive force with the magnet.

4. The actuator for a camera according to claim 2, wherein a height of the middle part in the first direction is smaller than a height of the magnet in the first direction.

5. The actuator for a camera according to claim 4, wherein a height difference between a highest portion of the upper part in the first direction and a lowest portion of the lower part in the first direction is greater than the height of the magnet in the first direction.

6. The actuator for a camera according to claim 1, wherein at least one of the upper part and the lower part includes a region having a smaller thickness than the thickness of the middle part.

7. The actuator for a camera according to claim 3, further comprising:
a first rail provided on at least one of the first and second frames and having a U-shaped cross-section; and
a second rail provided on at least one of the first and second frames in parallel with the first rail and having a V-shaped cross-section,
wherein the ball is arranged on the first and second rails, respectively, and
wherein the open portion is formed at a position biased toward the first rail.
